(19) United States
(12) Patent Application Publication
(10) Pub. No.: US 2011/0283022 A1
(43) Pub. Date: Nov. 17, 2011

(54) PROCEDES ET DISPOSITIFS DE SYNCHRONISATION, DANS UN RESEAU DE COMMUNICATION, POUR APPLICATIONS DE TYPE VENTE AUX ENCHERES EN TEMPS REEL

(75) Inventors: Tanguy Lesselin, Luxembourg (LU); Pascal Lahannier, Angicourt (FR)

(73) Assignee: SOKOZ, Luxembourg (LU)

(21) Appl. No.: 12/811,653

(22) PCT Filed: Dec. 31, 2008
(86) PCT No.: PCT/FR2008/001845

§ 371 Date: Sep. 30, 2010

(30) Foreign Application Priority Data
Jan. 4, 2008 (FR) 0850041

(51) Int. Cl. G06F 15/16

(52) U.S. Cl. 709/248

(57) ABSTRACT

A synchronization method and device for implementing auction sale applications in a communication network using a server and at least one customer terminal. When receiving (305) a message containing a reference to a predetermined moment, the message is processed (310) and a command from the customer terminal is inhibited (600) until the predetermined moment. When receiving an offer, a value linked to the sale is updated (515) and a moment from which the value can further be considered is determined. A message including the value and the moment is generated and transmitted (520) to the customer terminal. The moment is preferably determined on the basis of the moment at which the message is created and transmitted, and on the basis of communication parameters.

The present invention concerns auction type applications and more particularly synchronization methods and devices for implementing auction type applications via a communication network such as the Internet, enabling persons at different geographical places to participate dynamically in such auctions.

The principle of auctions consists in a procedure implemented by a third party whereby the price of one or more articles is determined as a function of the demand from potential purchasers in a given time interval in accordance with criteria of proposed price, required quantity and time of bids. Adjudication is the action whereby the third party organizing the auction assigns one or more articles to one or more bidders.

A plurality of types of auction exist, including English auctions, featuring upward bidding, and Dutch auctions, featuring downward bidding.

In upward bidding, a starting price is announced and, starting from the start of bidding, each bidder can make a bid higher than the highest bid, or higher than the starting price in the case of the first bid. Bidding terminates when there is only one bidder or at the end of a predetermined time-period.

In downward bidding, a predetermined starting price is announced, that price reducing continuously, starting from the start of bidding, until it reaches a reserve price. Bidding ends when a bidder is declared the buyer or when the reserve price is reached. The starting price may be determined as a function of the maximum selling price hoped for by the vendor.

In downward bidding when a plurality of articles is available, the starting price may be adjusted on each adjudication, i.e. reset to its initial value, or not.

In auctions, the time at which a bid is entered, for example accepting a price, proposing a price or proposing a quantity and a price, is essential and decisive. For example, in the case of a downward bidding type auction, adjudication concerns the first bidder. It is therefore necessary to determine the time at which a bidder makes their bid to compare it with the times at which other bids were made, if necessary.

In addition, the evolution of communication networks, notably the Internet, has contributed to the development of new modes of distribution of goods and services. For example, virtual exchange platforms known as marketplaces manage bidding and demand. Such platforms are generally implemented by third parties that offer secure transaction mechanisms.

However, because in particular of real time constraints concerning auctions, there is no satisfactory solution using such selling methods via communication networks such as the Internet.

To implement an auction via a communication network it is necessary to comply with the constraints imposed by this type of selling in order for all users to be treated equally. In particular, all users must have the possibility of bidding independently of transmission latency times that may be introduced by the communication network. Similarly, adjudication must be effected reliably.

The invention makes it possible to solve at least one of the above problems.

Thus the invention provides a synchronization method for real-time applications of auction type executed via a communication network by means of at least one server and at least one client station, this method comprising the following steps:

receiving and processing a message containing at least one reference to a predetermined time; and

on reception of said message, inhibiting at least one command of said at least one client station up to said predetermined time, said at least one command being used to respond to said message;

said steps being executed in said at least one client station.

Thus the invention makes it possible for all participants in an auction type application to participate simultaneously in such sales via a communication network by enabling each of them to have access to the same information to enable them to make bids starting from the same time. Temporary deactivation of at least part of the interface of the client stations and in particular of the devices used by users for bidding makes it possible to allow time for all pertinent variables (reference price, time, highest bidder and/or quantities) to be resynchronized and to return to a synchronized real-time system leading to perfect simultaneity of reference values.

Similarly, the invention makes it possible to prevent a bid being made erroneously when bidding has closed.

The invention further makes it possible to take account of the effects of the various communication network connection qualities that render the time to transmit information variable from one user to another. Thus, according to the invention, no client station is advantaged or disadvantaged by the quality of its connection to the network. In other words, all users have the same reference value at the moment the actions enabling them to bid are re-enabled. The concept of real time is thus limited according to time periods.

Said message advantageously further comprises at least one data item for updating at least one value stored in said client station, said method comprising a step of updating said at least one value, said updating step being executed in said at least one client station.

Messages sent by the server to the client stations are thus used to (re)synchronize the client stations as much from an application point of view as from a real time point of view.

In one particular embodiment, the method further comprises an initialization step during which a time reference is received from said server to enable synchronization of said at least one client station with said server.

The method advantageously further comprises a step of indicating the inhibition of said at least one command in order to warn the user.

In one particular embodiment, the method further comprises a step of entering at least one information item in response to said message and a step of transmitting said at least one information item to said at least one server to enable a user to transmit a bid.

The invention also provides a synchronization method for real-time applications of auction type executed via a communication network by means of a server and at least one client station, this method comprising the following steps:

receiving a message containing a bid;

determining at least one time from which said bid may be responded to; and

creating and transmitting to said at least one client station a message containing at least one reference to said time;

said steps being executed in said server.

Thus the invention makes it possible for all participants in an auction type application to participate simultaneously in such sales via a communication network by enabling each of them to have access to the same information to enable them to make bids starting from the same time. Temporary deactivation of at least part of the interface of the client stations and in particular of the devices used by users for bidding makes it possible to allow time for all pertinent variables (reference price, time, highest bidder and/or quantities) to be resynchronized and to return to a synchronized real-time system leading to perfect simultaneity of reference values.

The invention further makes it possible to take account of the effects of the various communication network connection qualities that render the time to transmit information variable from one user to another. Thus, according to the invention, no client station is advantaged or disadvantaged by the quality of its connection to the network.

In one particular embodiment, the method further comprises a step of updating at least one value stored in said server according to said bid contained in said received message, said at least one value being transmitted to said at least one client station in said transmitted message.

Messages sent by the server to the client stations are thus used to (re)synchronize the client stations as much from an application point of view as from a real time point of view.

The method advantageously further comprises an initialization step during which a time reference is transmitted to said at least one client station in order to enable synchronization of said at least one client station with said server.

In one particular embodiment, said time is determined as a function of the time at which said transmitted message is created or transmitted and at least one communication parameter of said communication network in order to limit the time periods for which said at least one command is inhibited. Thus the deactivation time may be adjusted as a function of the types of network through which the information streams pass.

The invention further provides a computer program comprising instructions adapted to execute each of the steps of the above method and a device comprising means adapted to implement each of the steps of the above method.

Other advantages, objects and features of the present invention emerge from the following detailed description given by way of nonlimiting example with reference to the appended drawings, in which:

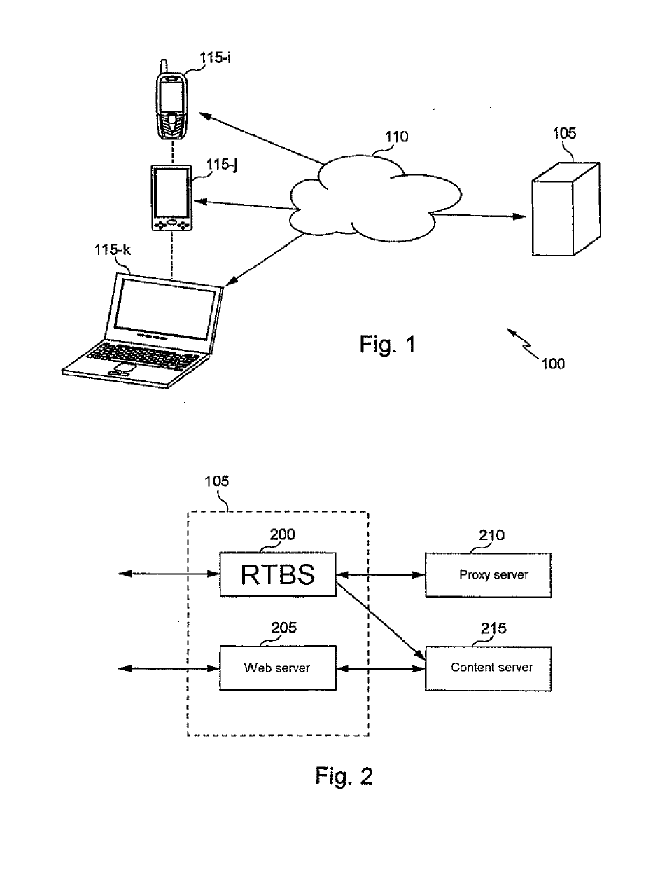

FIG. 1 illustrates diagrammatically an example of an environment in which the invention may be used to enable sales by auction via a communication network;

FIG. 2 illustrates more precisely the architecture used to manage auctions of the system 105 represented in FIG. 1;

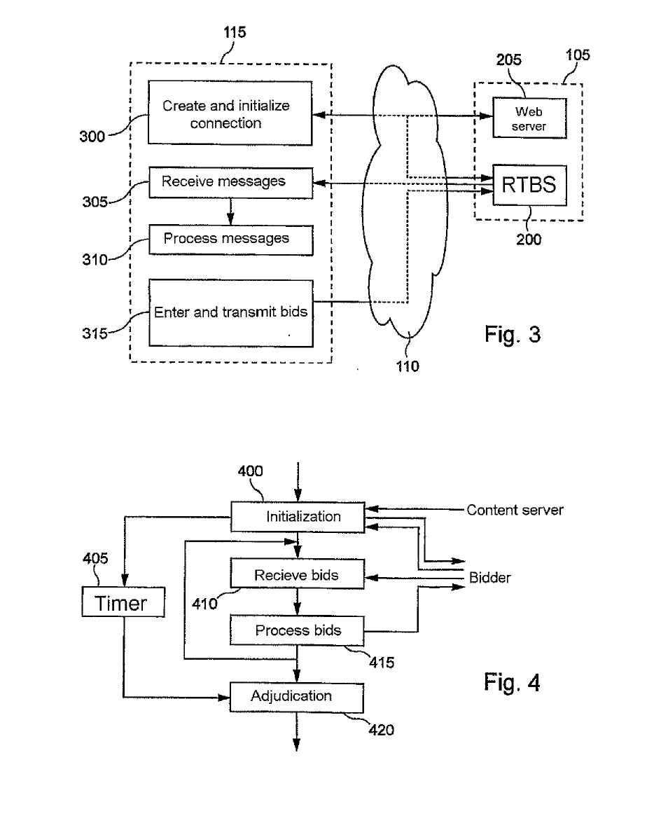

FIG. 3 illustrates the main modules of a client station for exchanging data with a real time bid server in order to receive information in real time specific to a bidding session and to enable the transmission of bids in real time;

FIG. 4 represents an example of an algorithm that can be used in a real time bid server to manage one or more auctions;

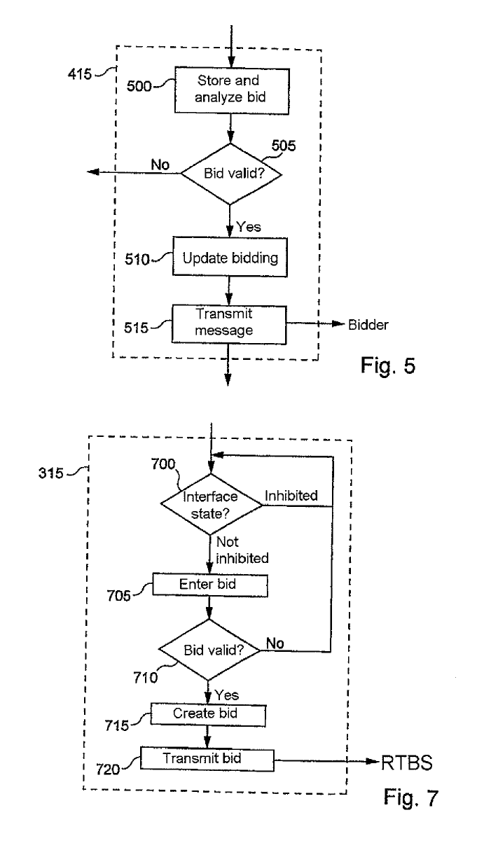

FIG. 5 illustrates an example of processing of bids received by a real time bid server;

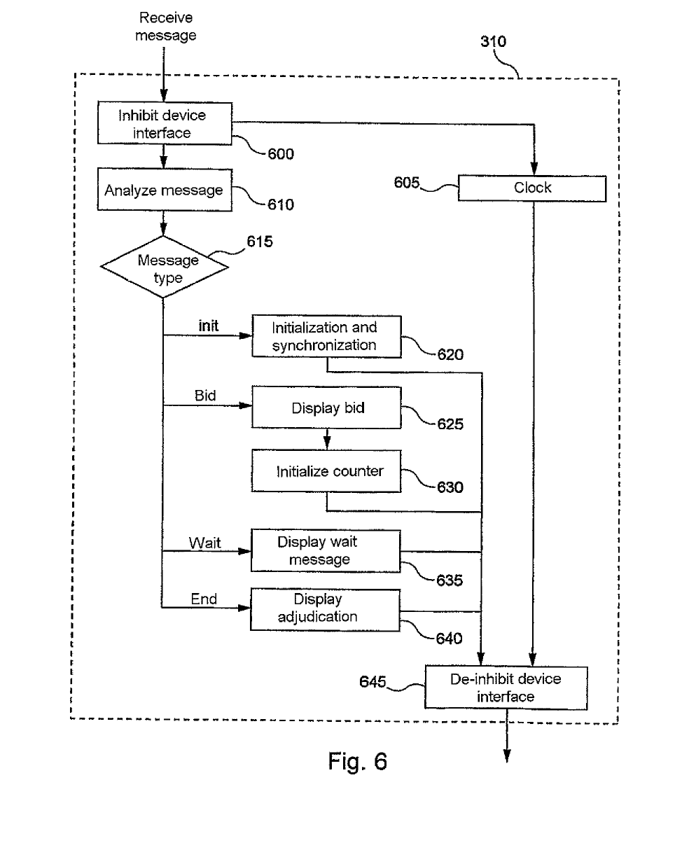

FIG. 6 illustrates an example of an algorithm that can be implemented in client stations to process messages received from a real time bid server; and

FIG. 7 illustrates an example of an algorithm adapted to capture and to transmit a bid from a client station.

Generally speaking, in a data processing system, a real time constraint is complied with when the information processing time is less than the reciprocal of the frequency at which the processed information changes. Furthermore, a real time constraint may be such that the processing result is at least as important as complying with the constraint linked to the time to execute the processing. This is referred to as a strong real time constraint.

Moreover, in a system based on the use of a network, to determine the information processing time it is necessary to take into account the time to transfer the information in the network and any lack of synchronization between components of the communication network.

Such a strong real time constraint applies to the field of auctions via a communication network. For example, if the processing time of an earlier bid is greater than that of a later bid, in a downward bidding type auction the adjudication may be erroneous.

Accordingly, one particular object of the invention is to respond to this strong real time constraint in auction type applications via a communication network.

FIG. 1 illustrates diagrammatically an environment 100 in which the invention may be implemented to enable auctions via a communication network.

As shown, a system 105 is connected to a communication network 110. Here the system 105 represents the system of a third party managing one or more auctions. A plurality of potential bidders may be connected to this system via the network 110 using personal devices or devices made available to them, referred to generically as client stations. For example, a first potential bidder uses a mobile telephone 115-i, a second potential bidder uses a personal digital assistant (PDA) 115-j, and a third potential bidder uses a personal computer 115-k. Other devices may be used, such as a television set provided with a user interface, for example a remote control, and connected to a communication network. The connections between the client stations, generically referred to as 115, and the communication network 110 are of standard cable or wireless type. They may be Ethernet or WiFi connections, for example.

The client stations 115 preferably comprise input means for entering and transmitting a bid and display means for displaying information such as a reference price and a quantity of articles. This information can alternatively or additionally be sent in vocal form.

Potential bidders receive information from the server 105, notably information linked to prices, quantities and time. Bids are entered via the client station interface using a real or virtual keyboard, for example.

Depending on the type of auction, a bid may be submitted by simply selecting a key or by selecting or entering one or more values, optionally followed by a confirmation or validation command.

The reference price is preferably always displayed on the client stations. Depending on the type of auction, the reference price is either transmitted by the system 105 or determined by the client stations.

The invention is aimed more particularly at the following four types of auction:

single downward bidding auctions in which the reference price falls continuously. The first bidder to transmit a bid in the form of an acceptance wins the auction. The auction duration, linked to the starting price and the price variation speed, is variable. Here it is between approximately ten seconds and a few minutes. A bid may be submitted by means of a single command;

single upward bidding auctions in which potential bidders have a limited time to bid, for example 3 seconds, starting from a starting price for a new bid. Each bid must furthermore comply with a predefined minimum increment. If no bidder transmits a bid during a predetermined time period, the adjudication is effected to the benefit of the last highest bidder (the sale may be cancelled if no bid has been placed). In a computer-based solution in which bids are made remotely, a plurality of alternate or complementary solutions may be envisaged, including:
using predefined keys each corresponding to a predetermined increment relative to the reference price visible to the bidder, for example to add one euro, two euros or five euros to the reference price, which selection may be validated or not by means of another key; and
entering and validating an amount corresponding to the bid;

bidding by the clock auctions in which the reference price falls from an initial value corresponding to a starting price until a bidder transmits a bid or until a reserve price is reached if no bid is received. Here the bid consists of a quantity (the price is that corresponding to the moment at which the user enters their bid). The stock of articles available is then reduced commensurately and the reference price is reset to its initial value (starting price) and starts to fall again until a new bid is sent. Alternatively, after a bid has been transmitted and accepted, the reference price may be determined as a function of the last acceptance price or as a function of a reevaluation of the starting price. The process is repeated until the stocks are exhausted or until the reserve price is reached. This type of bidding is particularly used to dispose of large quantities of identical articles. A bid may be placed by entering a quantity or by activating a key corresponding to a predetermined quantity;

multiple downward bidding auctions that differ from bidding by the clock auctions in that the current price is not reset after a bidder has made a bid. In multiple downward bidding, the price falls constantly and, when a bid is made, the quantity of articles is reduced by the value contained in the bid. Bidding ends when the number of articles reaches zero or when the reserve price is reached. Again, a bid may be made by entering a quantity or by activating a key corresponding to a predetermined quantity.

To each type of bidding there correspond specific commands accessible to users, i.e. potential bidders. The following table shows one example of commands that may be offered as a function of the type of auction.

| | Single | | Bidding | Multiple |
|---|---|---|---|---|
| | downward | Upward | by the | downward |
| | bidding | bidding | clock | bidding |
| “Buy” (or accept | X | | X | X |
| price) | | | | |
| “Enter price” | | X | | |
| “Enter quantity” | | | X | X |

To each type of bidding there also correspond variables with new reference values that are transmitted by the bidding server to all clients on each iteration of the bidding. The table below illustrates an example of variables that may be used as a function of the type of auction.

| | Unit | | Bidding | Multiple |
|---|---|---|---|---|
| | downward | Upward | by the | downward |
| | bidding | bidding | clock | bidding |
| Price | X | X | X | X |
| Highest bidder | X | X | X | X |
| Quantity | | | X | X |

FIG. 2 shows in more detail the architecture used to manage auctions of the system 105 represented in FIG. 1.

As shown, the system 105 operates within an architecture of the ‘N third parties’ type and here comprises two front-end servers 200 and 205 and two dedicated servers 210 and 215. The servers 200, 205, 210 and 215 may equally be sets of servers, also known as server farms.

The server 215, referred to as the application server or content server, contains and manages advertisements, i.e. offers for sale, previously published by users.

Each advertisement may be characterized by a product reference, a vendor, a starting price and a reserve price, a quantity, a bidding type and the date and time the bidding session is scheduled. Other information may be associated with these advertisements.

The server 215 incorporates a scheduler mechanism for programming bidding sessions in time. The server 215 transmits the information relating to the bidding sessions to the servers 200 and 205 in chronological order.

The real time bidding server (RTBS) 200 is dedicated to real-time management of bidding sessions, i.e. in particular to receiving bids transmitted by bidders for a given product, confirming the pertinence of a bid, updating the bidding variables, and broadcasting information to all the client stations 115 connected to the bidding session. The information transmitted to the client stations by the real time bidding server 200 includes updated bidding variables and synchronization data.

The web server 205 is connected to the application server 215. It therefore has access to data relating to the advertisements and to the schedule of bidding sessions that have ended, are in progress and are to come.

The web server 205 listens to information transmitted by the server 215, notably by the mechanism for scheduling bidding sessions, which enables it to know the parameters linked to bidding sessions in progress and to come. Those parameters notably group a unique identifier of a bidding session and a physical identifier of the real time bidding server 200 in which the session runs. The physical identifier comprises, for example, the network address of the real time bidding server and a reference to the protocol used.

The proxy server 210 is dedicated to managing bids that bidders have placed in advance.

The proxy server 210 is connected to the real time bidding server 200 and transmits bids to it during the bidding session, as if they were sent by bidders.

The client stations 115 are connected to the web server 205 and are thus able to access the application part, notably the advertisement management part. They are therefore able to access information relating to upcoming bidding sessions (chronology and parameters).

To participate in a bidding session, each client station 115 must be connected to the real time bidding server 200 using predefined network connectors in accordance with the parameters linked to a session. Network connectors, also known as sockets, are software interfaces with operating system services enabling use of the services of a network protocol.

The network connectors between the client stations 115 and the real time bidding server 200 used here make it possible to benefit from permanent network connections in read/write mode. These connections are advantageously secure connections and have a limited lifetime, as a function of the duration of the bidding session. The read mode makes it possible to receive information from the real time bidding server 200 while the write mode makes it possible to send information to the real time bidding server 200.

Some of the algorithms executed in the real time bidding server 200 are described with reference to FIGS. 4 and 5.

FIG. 3 shows the main modules of a client station 115 for exchanging data with the bidding system 105 and more particularly with the real time bidding server 200 in order to receive information in real time specific to a bidding session and to enable the transmission of bids in real time.

For sake of clarity, the standard modules necessary for the client stations to function, such as an operating system, are not shown.

The module 300 initializes the network connectors with the real time bidding server 200 by setting up a connection and identifying the user and the associated bidding session. It is assumed here that each client station 115 has previously connected to the web server 205, for example using a standard web link and the http protocol, and has been identified as a user of the platform.

The client stations 115 further comprise a module 305 for receiving messages transmitted by the real time bidding server 200 and a module 310 for processing the received messages. An example of an algorithm for processing received messages is described with reference to FIG. 6.

The client stations 115 also comprise a module 315 for entering bids and transferring them to the real time bidding server 200 during a bidding session. An example of an algorithm for entering and transmitting bids is described with reference to FIG. 7.

The set of modules 300, 305, 310, and 315 represents the client application part of each client station 115. Associated with the network connectors, the message reception module 305 and the bid sending module 315 are preferably autonomous and function in an event-based manner with no waiting time.

To maintain the pertinence and coherence of the information shared by the client stations 115, there is a (re)synchronization mechanism between the client stations 115 and the real time bidding server 200. This mechanism makes it possible in particular to block the bid sender module 315 until a given time in order for all the client stations 115 to receive the correct information and to be in a position to resume sending new bids on a common time reference.

FIG. 4 represents an example of an algorithm that may be executed in the real time bidding server 200 to manage one or more bidding sessions. It is assumed here that potential bidders are connected to the real time bidding server 200.

Before each bidding session, the application server 215 sends the real time bidding server 200 information specific to the session that is about to begin. As a function of that information, the module 400 prepares the environment specific to this bidding session and in particular the network connectors (for receiving bids) with the client stations 115. From this time, the real time bidding server 200 is ready to accept or to refuse connection requests from client stations 115.

The real time bidding server 200 uses a timer 405, i.e. an internal clock mechanism, to synchronize the beginning and the end of a bidding session.

Generally speaking, the module 400 calculates the initial duration and the end time of the bidding session (in the absence of bids) and initializes the timer 405 with the result of the calculations.

It should be noted that the calculation of the end time of the bidding session may be iterative, depending on the type of bidding. For example, for multiple upward and downward bidding, the end time of the session is recalculated or the bidding session is stopped when the remaining quantity of goods for each bid processed is zero (multiple bidding). In all cases, when the clock reaches the end time, the bidding session is stopped. After validation, the adjudication 420 is communicated to the client stations 115.

The module 400 is also responsible for the event-based mechanism for linking up client stations 115. For each new connection validated, the module 400 transmits the variables associated with the current session, whether it has started or not, directly to the client station 115.

The real time bidding server 200 is then placed in a configuration in which it is able to receive bids transmitted by bidders (step 410). Each bid received is processed immediately (step 415) to determine, if necessary, a new reference price and to advise the bidders of it, i.e. to transmit a message to the client stations including the new information for the sale. The step 415 is described in detail with reference to FIG. 5.

In addition, mechanisms in the client stations 115 and the real time bidding server 200 guarantee synchronism in time. Using the timer 405 makes it possible to initialize a new time reference for each bidding session, common to the bidding server and to the client stations. If the time t₀ corresponds to the start of the session, all exchanges between the real time bidding server 200 and the client stations 115 are effected on the basis of the time t₀ associated with the bidding session. This time reference may be understood as being representative of a given time, the representation of that time being the same for the bidding server and for all the client stations. This representation may be in date/time form, the time being sufficiently accurate to distinguish two bids. The time is accurate to within one thousandth of a second, for example.

FIG. 5 illustrates an example of processing bids received by the real time bidding server 200. Each bid received is stored and analyzed as soon as it is received (step 500). A test specific to each type of bidding is then effected to determine if the bid is valid (step 505). For upward bidding, in which a bid must be higher than the current price, the test may in particular apply to the amount of the bid. Another test may consist in verifying that the bidding session has not ended, in particular for single downward bidding. These tests are carried out in particular because the transmission times of the instructions may be different for different users: a bid sent at a time tⱼ by one client station may arrive after a bid sent at a time tₖ (where tⱼ<tₖ) by another client station.

If the bid is not valid, it is ignored.

On the other hand, if the bid is valid, the bidding variables are updated (step 510). As indicated above, these variables are a new reference price or a quantity of products, for example.

If the bidding variables are updated, a message containing these variables in particular and at least an indication relating to the time tᵢ from which new bids may be sent is created and then transmitted to all the client stations (step 515). Depending on the type of bidding, this message terminates the auction or the information contained in it is used as a basis for further bidding.

Alternatively, the indications relating to the times at which new bids may be sent and the new values of the bidding variables are transmitted to the client stations by the server in a number of separate messages. For example, a first type of message may be used to transmit indications relating to the times from which new bids may be sent and a second type of message may be used to transmit the new values of the bidding variables.

The time tᵢ from which new bids may be sent by the client stations is determined, for example, by the time tₜᵣₐₙₛₘᵢₛₛᵢₒₙ at which the message is created or transmitted by the server to the client stations and by a delay delta needed to transmit data across the communication network (tᵢ=tₜᵣₐₙₛₘᵢₛₛᵢₒₙ+delta). This delay may be predetermined. This delay delta may equally be determined by the real time bidding server 200, before or during the auction, by estimating the time necessary for a message transmitted by the latter to be received by all the client stations of users participating in the sale. This delay may be weighted, notably to take account of the variability of the time to transmit messages across the communication network. The delay delta may be determined according to other criteria.

The indication relating to the time tᵢ from which new bids may be sent might be a representation of the time tᵢ such as the coded date and time or, for example, a representation of the time difference between the times tᵢ and t₀ or and tᵢ₋₁ and tᵢ, the time tᵢ₋₁ representing the time from which new bids may be sent in response to the reception of the preceding message.

FIG. 6 shows an example of an algorithm that may be implemented in the client stations to process messages received from the real time bidding server 200 corresponding to the module 310 from FIG. 3.

When, during an auction, a message is received from the real time bidding server 200, a freeze mechanism (steps 600 and 645) is put in place for a particular time. This freeze time is determined as a function of the time of reception of the message and the time from which new bids may be sent. This mechanism may be reflected in commands to block, deactivate or inhibit the user interface in order to prevent the user from entering and transmitting a bid. In one particular embodiment, at least part of the user interface is inhibited up to a predetermined time tᵢ (at least one characteristic of which is received from the real time bidding server), i.e. when one or more real or virtual keys are deactivated and no longer produce an effect when activated.

This freeze mechanism makes it possible to (re)synchronize all the client stations and, for example, to prevent a bidder from being able to transmit a bid in response to a new reference price until all the bidder devices have received the new reference price.

Synchronizing the client stations 115 with the real time bidding server 200 is based on sharing and using a common time reference. All exchanges, both sending and receiving, are thus synchronized to this time reference.

Accordingly, the freeze and thaw mechanism is implemented in all the client stations 115 in the same way: the time tᵢ common to all the client stations represents the end of the freeze period. This information being the same for all client stations 115, all client stations are (re)synchronized. All the client stations are de-inhibited at the same time tᵢ. It is therefore possible for all users to respond to a bid at the same time.

To this end, a clock is used to determine the time at which the interface is de-inhibited, i.e. the time from which it is possible to send bids (step 605).

An indication is advantageously provided to the user to warn him/her that the interface is at least partly inhibited and that it is not possible to enter and/or transmit bids. By way of illustration, a particular sound may be emitted when the interface is partially inhibited. Alternatively or additionally, a message may be displayed on the screen of the client station or certain parts, such as a virtual keyboard, may be grayed out.

Furthermore, on reception of a message from the real time bidding server 200, the new reference values are updated.

In parallel with this, the received message is analyzed (step 610) to determine its nature (step 615). Here, the message may be an initialization message, a bid update message, a waiting message or an end message.

An initialization message is received by a client station 115 as soon as it connects to the real time bidding server 200. This single message includes the initial values of the variables linked to the bidding session.

On reception of this message, the client station 115 may synchronize with the real time bidding server 200. As indicated above, this message includes information relating to the time reference t₀ used thereafter for exchanges with the real time bidding server 200 and for the synchronization calculations. This message also contains the remaining time (“start”) before the bidding session begins (thus the session begins at the time t₀+start).

This message may contain other information. For example, in the case of bidding by the clock, the message may contain indications relating to the evolution of the price as a function of time. Accordingly, using these indications and where appropriate the starting price and the duration of the sale, a client station 115 is able to determine the decreasing evolution curve of the reference price as a function of time without it being necessary to transmit all the data.

A bid updating message contains the new reference values for the bidding and at least one indication relating to a time tᵢ from which it is possible to capture and/or transmit new bids.

When a bid update message is received, the new reference values are preferably displayed on the screen (step 625) and the parameters of the auction are adjusted (step 630). For example, the current reference price is replaced by the received reference price, the quantity of articles available is replaced by the quantity of articles available and the delay authorized for bidding is reset.

The main purpose of a waiting message is to inhibit the client stations and to inform potential bidders that a sale has ended and that it is no longer possible to bid. This message is used in single downward bidding and bidding by the clock and for the last unit available in multiple downward bidding. This message is preferably transmitted as soon as the real time bidding server receives a valid bid. It prompts participants in the bidding session (and any spectators) to wait while the server receives and processes any simultaneous concurrent bids.

The purpose of an end message is to end a bidding session. It is the last message received by a client station for a particular bidding session. This message includes information relating to the end of the bidding session, for example prices, names of winners and any associated quantities.

Starting from reception of this message, the connection with the real time bidding server 200 is preferably lost and ends the real time bidding session.

At the predetermined time tᵢ for which a reference is received via a message transmitted by the real time bidding server 200, the client station interface 115 is de-inhibited (step 645). The client station may then be used to enter and transmit a bid.

FIG. 7 shows an example of an algorithm adapted to enter and transmit a bid. This algorithm is implemented in the FIG. 3 module 315, for example.

Firstly, a first test is executed to determine the interface status of the client station 115 (step 700). This test is repeated for as long as the interface is at least partly inhibited.

If the interface of the client station 115 is not inhibited, the bidder using the client station 115 may make a bid (step 705). As indicated above, the type of command accessible to the user depends on the type of bidding used in the session in progress.

A test is then advantageously effected to determine if the bid is valid (step 710). For example, this test may consist in comparing the amount of the bid to the reference price (upward bidding) or the required number of articles to the number of articles available (bidding by the clock).

If the offer is not valid, for example if the amount is less than the reference price or if the number of articles required is greater than the number of articles available, the bidder may enter a new bid after the client station has verified that the status of the interface allows it (steps 700 to 710).

If the bid is valid, the offer is formalized before it is transmitted to the real time bidding server 200 (step 715). The formalization of the offer is linked to the auction software and/or to the communication protocol used between the client station 115 and the real time bidding server 200.

The bid is then transmitted to the real time bidding server 200 (step 720).

When a bid has been transmitted by the client station 115, it is possible to inhibit its interface momentarily in order to prevent the bidder transmitting a second bid immediately after the first. Such a command may have the object of protecting the bidder against a misoperation, such as an unintentional double input, for example clicking twice, or be linked to a commercial strategy.

Naturally, to satisfy specific requirements, a person skilled in the field of the invention can apply modifications to the foregoing description.

1. Synchronization method for real-time applications of auction type executed via a communication network by means of at least one server and at least one client station, this method being characterized in that it comprises the following steps:
receiving (305) and processing (310) a message containing at least one reference to a predetermined time; and
on reception of said message, inhibiting (600) at least one command of said at least one client station up to said predetermined time, said at least one command being used to respond to said message;
said steps being executed in said at least one client station.

2. Method according to claim 1 wherein said message further comprises at least one data item for updating at least one value stored in said client station, said method comprising a step of updating said at least one value, said updating step being executed in said at least one client station.

3. Method according to claim 1 further comprising an initialization step during which a time reference is received from said server.

4. Method according to claim 1 further comprising a step of indicating the inhibition of said at least one command.

5. Method according to claim 1 further comprising a step of entering at least one information item in response to said message and a step of transmitting said at least one information item to said at least one server.

6. Synchronization method for real-time applications of auction type executed via a communication network by means of a server and at least one client station, this method being characterized in that it comprises the following steps:
receiving a message containing a bid;
determining at least one time from which said bid may be responded to; and
creating and transmitting (520) to said at least one client station a message containing at least one reference to said time;
said steps being executed in said server.

7. Method according to claim 6 further comprising a step (515) of updating at least one value stored in said server according to said bid contained in said received message, said at least one value being transmitted to said at least one client station in said transmitted message.

8. Method according to claim 6 further comprising an initialization step during which a time reference is transmitted to said at least one client station.

9. Method according to claim 6 wherein said time is determined as a function of the time at which said transmitted message is created or transmitted and at least one communication parameter of said communication network.

10. Computer program comprising instructions adapted to execute each of the steps of the method according to claim 1.

11. Device comprising means adapted to execute each of the steps of the method according to claim 1.

12. Method according to claim 2 further comprising an initialization step during which a time reference is received from said server.

13. Method according to claim 2 further comprising a step of indicating the inhibition of said at least one command.

14. Method according to claim 2 further comprising a step of entering at least one information item in response to said message and a step of transmitting said at least one information item to said at least one server.

15. Method according to claim 7 further comprising an initialization step during which a time reference is transmitted to said at least one client station.

16. Method according to claim 7 wherein said time is determined as a function of the time at which said transmitted message is created or transmitted and at least one communication parameter of said communication network.

17. Method according to claim 8 wherein said time is determined as a function of the time at which said transmitted message is created or transmitted and at least one communication parameter of said communication network.
